(19) United States
(12) Patent Application Publication
(10) Pub. No.: US 2007/0136369 A1
(43) Pub. Date: Jun. 14, 2007

(54) Program sharer

(76) Inventor: Bruce Hsu, Taipei (TW)

Correspondence Address: PRO-TECHTOR INTERNATIONAL SERVICES, 20775 NORADA CT., SARATOGA, CA, 95070, US

(21) Appl. No.: 11/297,876

(22) Filed: Dec. 8, 2005

(51) Int. Cl. G06F 17/00

(52) U.S. Cl. 707/104.1

(57) ABSTRACT

The present invention provides a program sharer software that uses technology including storage systems on servers and data access redirection to enable frequently used software (such as document editing software, program development tools, drawing software, ERP software, CAD/CAM software mail software, and so on,) to be executed on client terminals, when, in fact, the software is installed on centralized management software servers. The data access redirection technology in the Windows OS is separated into file redirection, registry redirection, local facilities usage and font installation.

### BACKGROUND OF THE INVENTION

(a) Field of the Invention

The present invention relates to a program sharer, that enables front-end computers to use and execute an operating environment of a host terminal without the need for installing any software on the front-end computers other than operation systems, and without placing a strain on hardware resources of the host terminal such as CPU, memory, and so on. Moreover, software of the host computer terminal are loaded into the front-end computers for execution and use thereon.

(b) Description of the Prior Art

Conventional software design is primarily divided into two major portions: one portion is an algorithm 101, and the other portion is data access 102, as depicted in FIG. 1, wherein examples of the algorithm 101 include word processing, digital arithmetic, graphic processing, commercial logic, and so on. The data access 102 accesses data in a data storage system 104 through a kernel service system 103. The kernel service system 103, Is a service system such as Microsoft Windows Operation System (Windows OS). The data storage system 104 is provided with two large storage systems, wherein one is a file system 1041, and the other is a registry system 1042. The file system 1041 is responsible for accessing software execution code and data files needed by the software, such as graphics, sound, and so on. The registry system 1042 is responsible for accessing software related settings, such as file access paths, and so on.

### SUMMARY OF THE INVENTION

Referring to FIG. 2, in order to avoid repeat installation and maintain execution efficiency of software, the present invention includes a kernel service system 13 beneath a Windows OS data access 12 that enables software, which is actually installed on centralized management software servers, to be executed on a client terminal by means of network 14 data access redirection technology. The software servers, which include a storage system on server 115 and a storage system on server 216, are internally configured with file systems 151, 161 and registry systems 152, 162 respectively.

In order to achieve the aforementioned constructs in a Windows OS, the present invention separates the program sharer system into the following four portions: file redirection, registry redirection, local facilities usage and font installation, which enable users to run any software on client terminals through the program sharer of the present invention, thereby achieving considerable savings in time and cost of installation, maintenance, updating and uninstalling of software, as well as changing the concept that software must be installed in order to use. Desktop computer or notebook computer users can easily use the present invention to save valuable time, thereby greatly conveniencing and simplifying information lifestyle and improving efficiency.

### DETAILED DESCRIPTION OF THE PREFERRED EMBODIMENTS

1. File Redirection:

Referring to FIG. 3, which shows a flow chart block diagram of a conventional application file access, wherein applications 201 use Win32 API Calls 2011 to enter a Win32 Subsystem 202, API being an abbreviation for Applications Program Interface. The aforementioned procedure is part of an observable platform user mode, which then passes through a system service interface 2021 of an unobservable platform kernel mode and enters an I/O manager 203. The procedure then enters file system drivers 204 and storage device drivers 205 through an IRP passed to driver dispatch routine 2031, and finally enters a logical volume 206, which, in the current market, generally includes a floppy disk drive, a hard disk drive, a CD-ROM drives, and so on.

Referring to FIG. 4, which shows a flow chart block diagram of application file access according to the present invention, which, under the precondition that the source code is not modified, enables access to remote files by adopting a method whereby a related file access portion of the system service interface 2021 passes through the I/O manager 203 and the IRP driver dispatch routine 2031, and is then redirected to remote file access by means of redirector file system drivers 24 and protocol drivers 25 to a network 26.

2. Registry Redirection:

Referring to FIG. 5, which shows a flow chart block diagram of registry redirection according to the present invention, wherein the registry is distinct from the file system. The registry stores a large number of settings related to the hardware. Applications 31 use the Win32 API calls 311 to enter the Win32 subsystem 32, and then redirection rules 33 enable selection of either a local registry 34 or a remote registry 36 through a network 35. Hence, rule-based redirection of registry data enables unhindered use of local hardware (such as network cards, printers, and so on).

3. Local Facilities Usage:

Referring to FIG. 6, which shows a flow chart block diagram of local facilities usage access according to the present invention, wherein local facilities, such as network cards, printers, RS 232, USB, and so on, use registry stored settings during the course of access. Hence, local facilities-related rules 43 are used to enable unhindered use of such local facilities.

4. Font Installation:

Referring to FIG. 7, which shows a flow chart block diagram of a conventional Windows Operation System font cache, wherein applications 501 use Win32 API Calls 5011 to enter a Win32 Subsystem 502, and access local font files 504 by way of a font cache 503.

Referring to FIG. 8, which shows a flow chart block diagram of a Window OS font cache according to the present invention, wherein applications 51 use Win32 API Calls 511 to enter a Win32 Subsystem 52 and integrate with local font files 54 and remote font files 56 through a modified font cache 53 and a network 55 respectively.

Advantages of the present invention:
1. Achieves considerable savings in time and cost of installation, maintenance, updating and uninstalling of software.

(1) Centralized management of all programs, apart from the host computer, there is no need to further install any applications on any client computers apart from a basic operation system.

(2) Unified updating of program versions, thereby eliminating the need to maintain computer software of all computers one by one.

(3) Program operating screen or execution environment are identical to original single computer state, thereby eliminating additional cost of learning or setting up.
2. Integrates software/hardware resources within a business, thereby improving investment benefits.

All computer users only need authorization, which can be invoked at anytime and transferred to any computer program, thereby providing the same convenience as local execution. Software/hardware of the entire business can be fully integrated and made use of, thereby improving software/hardware investment benefits.

The present invention is characterized in having:
1. Centralized management of programs, dispersed execution, and combined advantages of Terminal and Client/Server structure.
2. Local peripheral hardware usage, including CPU, memory, printer, and so on.
3. No delay problem in mouse operation.
4. No graphic color restrictions, apart from that imposed by local support.
5. No graphic display delay problem.
6. Suitable for running drawing or multimedia player programs.

Suitable Operation Systems of the Present Invention:

If a Microsoft 2000/2003 system is installed on the host computer terminal, then the front-end operation system must also be Microsoft 2000/2003 in order to operate. If a Microsoft XP Professional system is installed on the host computer terminal, then the front-end operation system must also be Microsoft XP Professional in order to operate

In conclusion, the present invention enables front-end computers, which have no application software installed, use and execute the operating environment of the host computer terminal. Moreover, the present invention will not place a strain on hardware resources of the host computer terminal, such as CPU, memory, and so on. The front-end computers need only have an operation system installed, without any further software installed, and software of the host computer terminal can be loaded into the front-end computers for execution and use thereon.

It is of course to be understood that the embodiments described herein is merely illustrative of the principles of the invention and that a wide variety of modifications thereto may be effected by persons skilled in the art without departing from the spirit and scope of the invention as set forth in the following claims.

### BRIEF DESCRIPTION OF THE DRAWINGS

FIG. 1 shows a flow chart block diagram of a conventional software design.

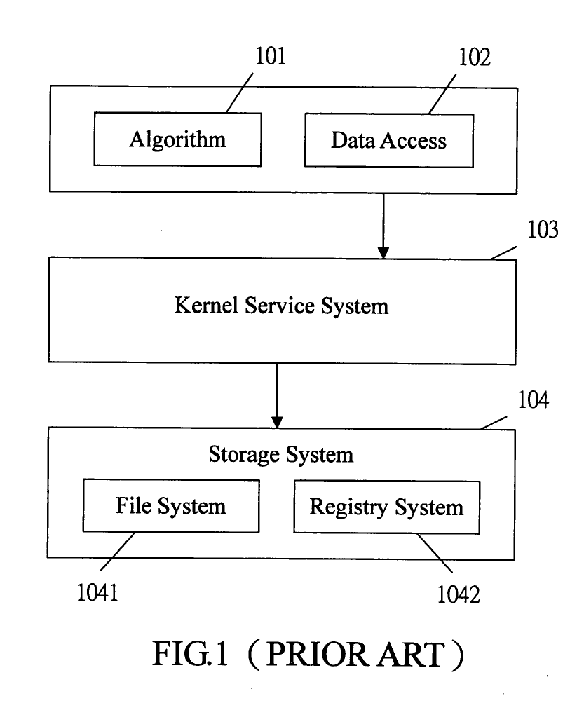

FIG. 2 shows a flow chart block diagram of a software design using data access redirection art according to the present invention.

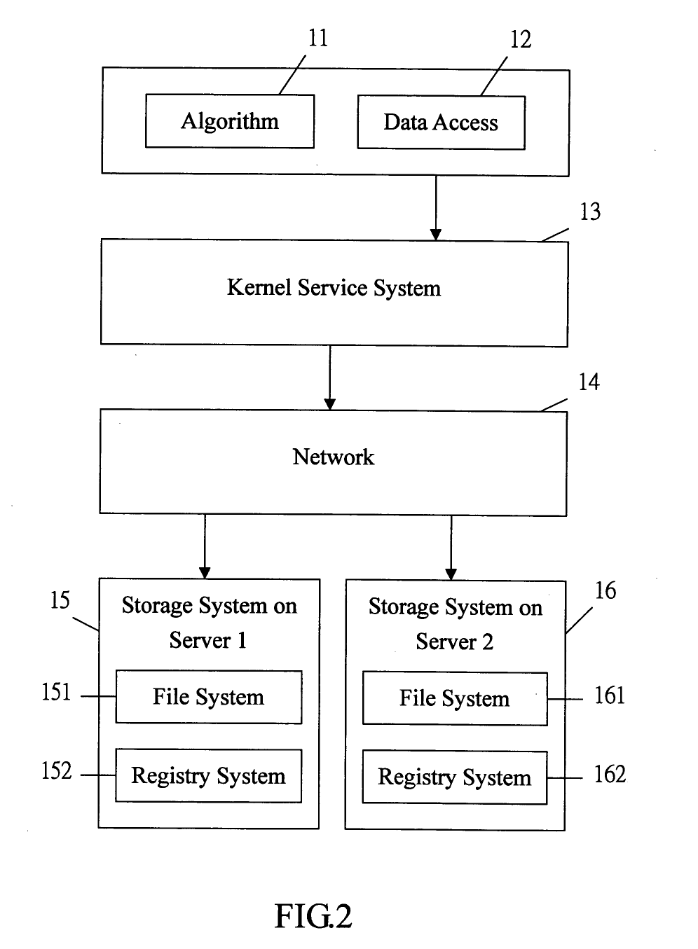

FIG. 3 shows a flow chart block diagram of a conventional application file access.

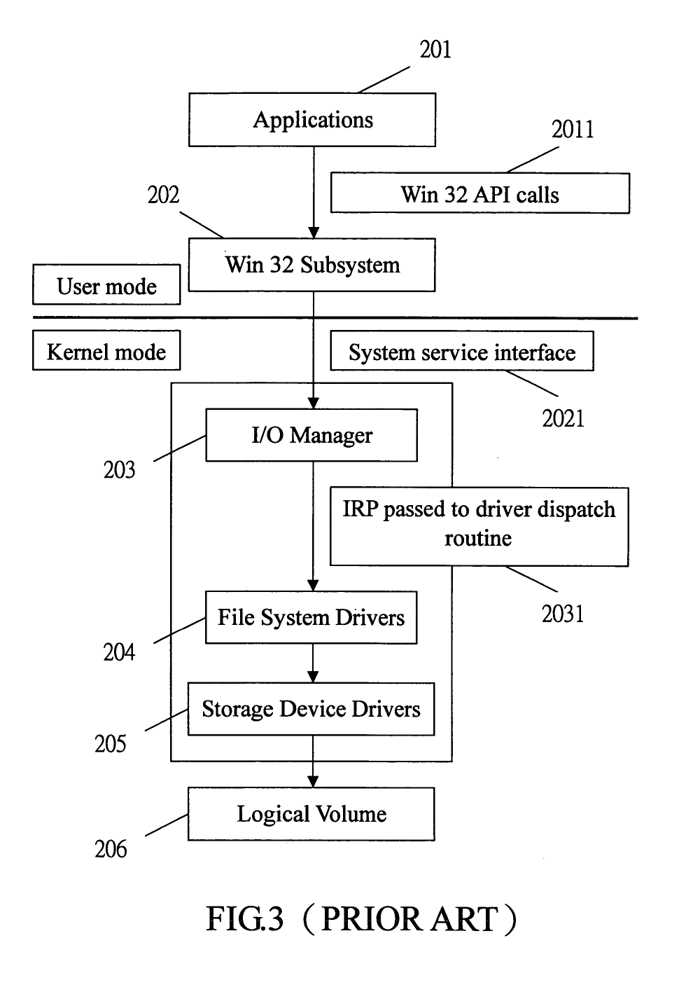

FIG. 4 shows a flow chart block diagram of application file access according to the present invention.

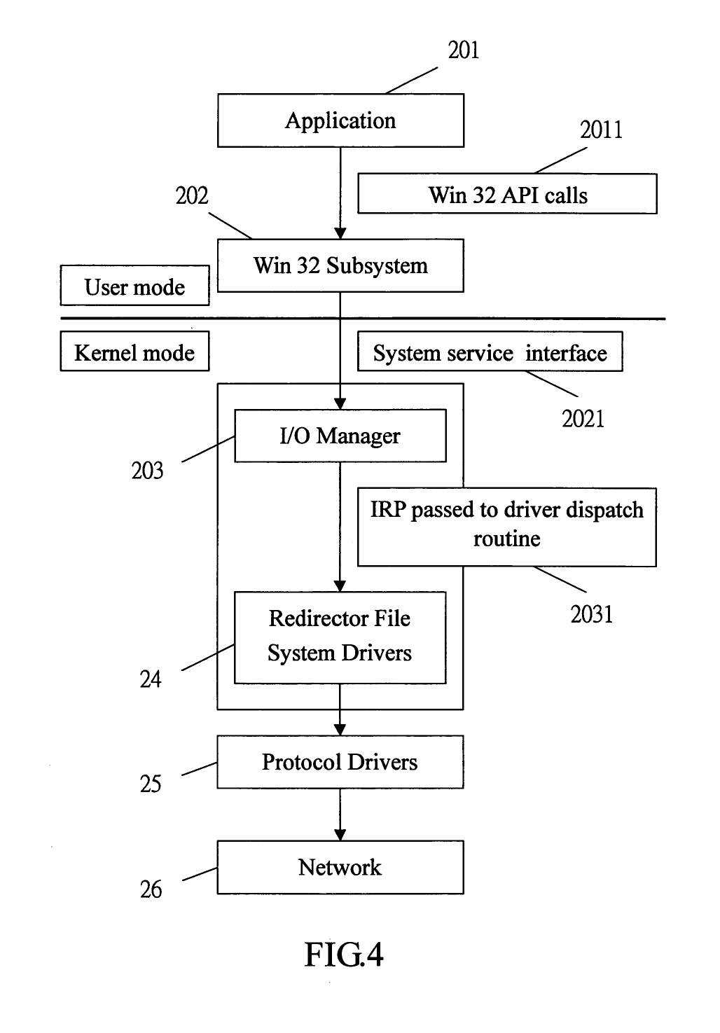

FIG. 5 shows a flow chart block diagram of registry redirection according to the present invention.

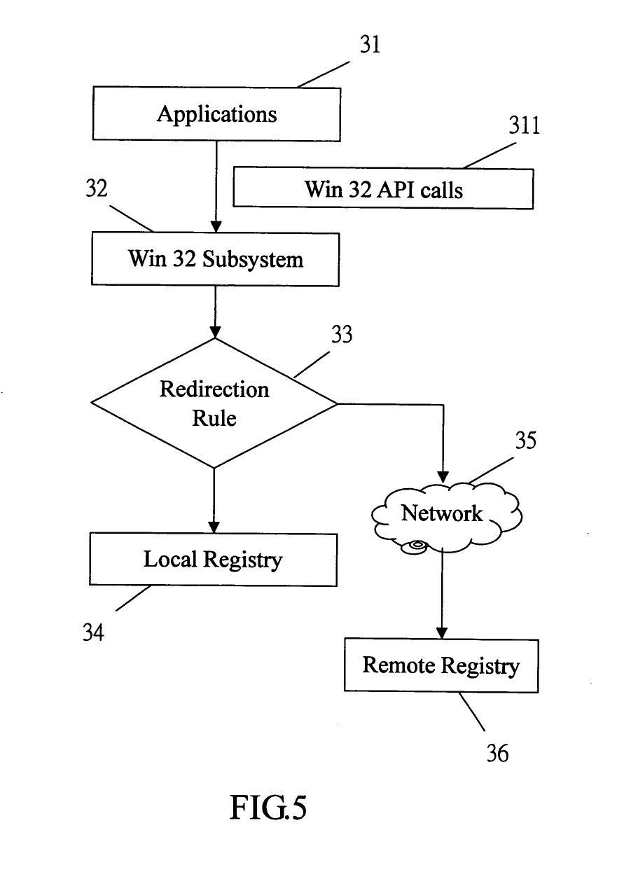

FIG. 6 shows a flow chart block diagram of local facilities usage access according to the present invention.

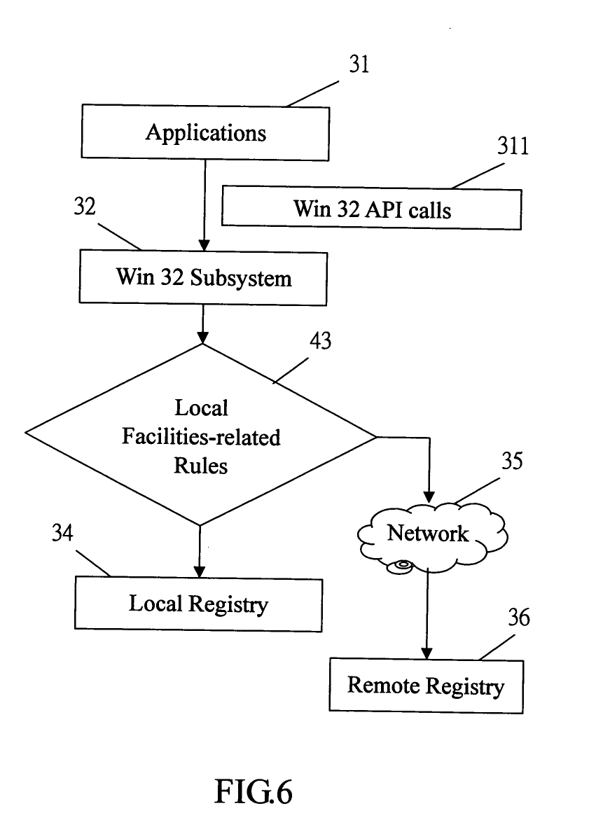

FIG. 7 shows a flow chart block diagram of a conventional Window OS font cache.

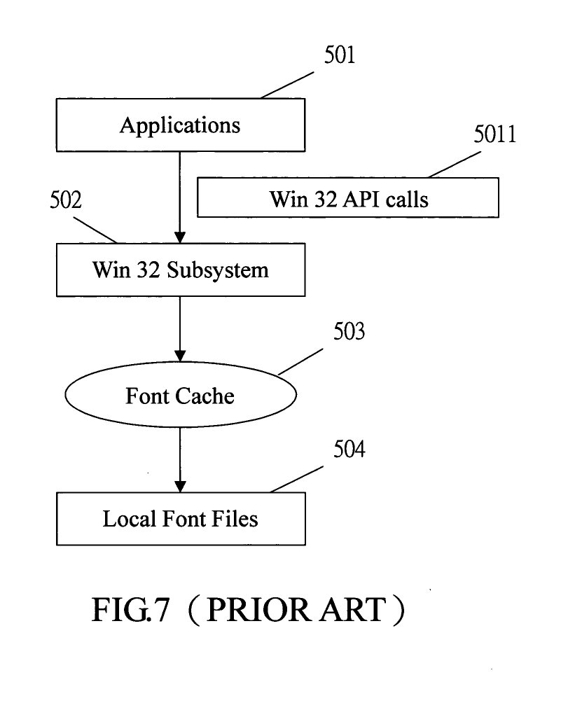

FIG. 8 shows a flow chart block diagram of a Window OS font cache according to the present invention.

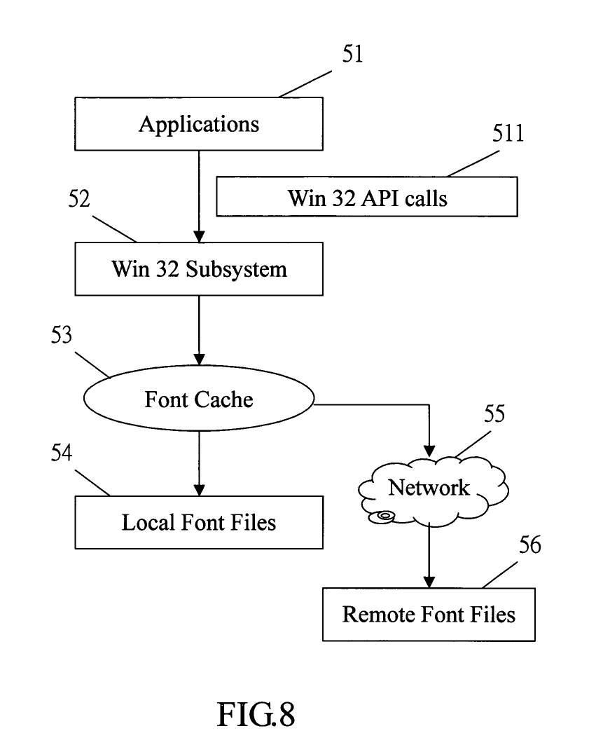

What is claimed is:

1. A program sharer that enables front-end computers, which have no application software installed, use and execute the operating environment of a host computer terminal; the program sharer comprises:
storage systems on servers, which use data access redirection to enable software installed on software servers to be executed on client terminals; and
redirector file system drivers, which are able to intercept related file access of a system service interface and redirect to a remote file access.

2. The program sharer as recited in claim 1, wherein a file system replaces a registry, and rule-based redirection of registry data enables unhindered use of local hardware.

3. The program sharer as recited in claim 2, wherein the hardware is all local hardware of a network card.

4. The program sharer as recited in claim 2, wherein the hardware is all local printer hardware.

5. The program sharer as recited in claim 1, wherein the file system replaces local facilities, and uses registry access to settings, and establishes corresponding registry redirection rules to enable unhindered use of equipment.

6. The program sharer as recited in claim 5, wherein the local facilities are all local hardware of a network card.

7. The program sharer as recited in claim 5, wherein the local facilities are all local printer hardware.

8. The program sharer as recited in claim 5, wherein the local facilities are all local RS-232 hardware.

9. The program sharer as recited in claim 5, wherein the local facilities are all local USB hardware.

10. The program sharer as recited in claim 1, wherein file system are font files, and the Windows OS uses a modified font cache to integrate local and remote font files.
